(19) United States
(12) Patent Application Publication
(10) Pub. No.: US 2026/0062316 A1
(43) Pub. Date: Mar. 5, 2026

(54) METHOD FOR REMOVING BINDER FROM SPENT CATHODE ACTIVE MATERIAL

(71) Applicants: NISSAN NORTH AMERICA, INC., Franklin, TN (US); Michigan Technological University, HOUGHTON, MI (US)

(72) Inventors: Lei PAN, Houghton, MI (US); Kaiwu HUANG, Hancock, MI (US); Kulwinder DHINDSA, Westland, MI (US); Shweta LINGAYAT, West Bloomfield, MI (US); Zongtang FANG, Northville, MI (US); Dianne Atienza HAY, Hartland, MI (US)

(21) Appl. No.: 18/819,833

(22) Filed: Aug. 29, 2024

(51) Int. Cl. C01G 53/00; B01D 17/02; H01M 10/54

(52) U.S. Cl. CPC C01G 53/44; B01D 17/0214; H01M 10/54; C01P 2006/40

(57) ABSTRACT

A method is provided for removing a binder from a spent cathode active material. The method includes mixing the spent cathode active material with water to form a first mixture. The spent cathode active material includes cathode active material particles and the binder. The method further includes grinding the first mixture to separate the binder from the cathode active material particles, mixing the first mixture with a hydrocarbon liquid, agitating the hydrocarbon liquid and the first mixture and forming an oil phase and a water phase, and separating the oil phase from the water phase. The first mixture contains the cathode active material particles, the binder and the water. The oil phase contains the hydrocarbon liquid and the binder, and the water phase contains the cathode active material particles and the water.

### BACKGROUND

### Field of the Invention

The present invention generally relates to a method of removing a binder from a spent cathode active material so that the spent cathode active material can be recycled to form a new cathode active material. The method includes mixing the spent cathode active material with water to form a first mixture. The spent cathode active material includes cathode active material particles and the binder. The method further includes grinding the first mixture to separate the binder from the cathode active material particles, mixing the first mixture with a hydrocarbon liquid, agitating the hydrocarbon liquid and the first mixture and forming an oil phase and a water phase, and separating the oil phase from the water phase. The first mixture contains the cathode active material particles, the binder and the water. The oil phase contains the hydrocarbon liquid and the binder, and the water phase contains the cathode active material particles and the water. The present invention also relates to a system for removing a binder from a spent cathode active material.

### Background Information

Lithium-based batteries that include lithium metal anodes or lithium-based cathode material are desirable because they have a high energy density and, thus, can generate a large amount of power with a relatively thin electrode structure. This in turn permits a reduction in the size of the battery as compared with other conventional batteries including anodes made of carbon or silicon.

Cathode active materials are one of the most expensive components in lithium-ion batteries. In particular, cobalt is very expensive, and there is a limited supply of other metals typically used in cathode active materials for lithium-ion batteries, such as lithium nickel manganese cobalt oxide (LiNiMnCoO₂, also commonly referred to as “NMC”). Therefore, it is desirable to recycle cathode active materials once the batteries have been used by removing the cathode material from the cathode current collector and separating the cathode active material from any binder in the cathode material to obtain clean cathode active material for use in a new battery. It is particularly difficult to obtain high purity cathode active material at a high yield from spent cathode active material that is recovered from a used battery that has a state of health (“SOH”) of 50% or less.

There are several known methods for indirectly recycling the cathode active material. For example, one conventional indirect recycling method involves burning or melting the entire lithium-ion battery at a high temperature. However, this method is expensive and results in a large loss of lithium which must then be replenished. Another conventional indirect recycling method involves hydrometallurgical processing of the cathode using a leaching agent to leach out individual metal for the cathode active material. However, once the individual metals have been leached, purified, and precipitated/crystallized, the cathode active material must be re-synthesized to manufacture a new cathode active material. Therefore, it is desirable to directly recycle the used cathode material such that additional synthesis or manufacturing from the individual metal precursors is not required.

Conventional direct recycling methods also have several drawbacks. For example, one known method involves separating the cathode active material from the binder using a large amount of solvent, then replenishing the lithium lost during battery cycling after the cathode active material is recovered. Another known method involves using a solvent such as N-methyl-2-pyrrolidone (“NMP”) or triethyl phosphate (“TEP”) to remove the fluorine. However, conventional solvents used to separate cathode active material and binder are both expensive and bad for the environment. Furthermore, conventional recycling methods cannot sufficiently separate the cathode active material particles from the binder to achieve a high purity cathode active material. Therefore, these recycling methods do not achieve a high yield of active material sufficient to justify their high cost and negative environmental effects. A further conventional method involves hydrothermal treatment of the spent cathode active material in an aqueous lithium ion solution to remove binder material and relithiate the cathode active material, followed by separation of the relithiated cathode active material from the solution. However, this method may destroy the morphology of the cathode active material due to the high temperature required and does not sufficiently remove the binder from the spent cathode active material, thereby limiting the specific capacity of lithium-ion batteries that include such recycled cathode active materials.

Therefore, further improvement is needed to sufficiently remove binder from the spent cathode active material without adversely affecting the morphology or structure of the cathode material and with minimal environmental impact. In particular, it is desirable to obtain a high purity cathode active material at a high yield from spent cathode active material recovered from a deeper cycled battery (i.e., having a SOH that is 50% or lower).

### SUMMARY

It has been discovered that fluorine-containing binder such as PVDF can be removed from spent cathode active material particles such as NMC to a greater degree and with a high yield by using an oil agglomeration method. In particular, by using an oil agglomeration method in which the spent cathode active material is mixed with water and then agitated with oil, the binder can be separated from the cathode active material by forming two phases - an oil phase containing the binder and a water phase containing the spent cathode active material - and separating the oil phase from the water phase.

Furthermore, it has been discovered that by grinding the spent cathode active material after it has been mixed with water, the binder can be better removed from the surface of the spent cathode active material particles before mixing with the oil such that a higher yield and higher purity cathode material can be attained when the oil and water phases are separated.

Therefore, it is desirable to provide a method for directly recycling the cathode active material of a used battery by grinding a spent cathode active material mixed with water, agitating the mixture with oil and forming an oil phase and a water phase, and separating the oil phase containing the binder from the water phase containing the cathode active material.

In view of the state of the known technology, one aspect of the present disclosure is to provide a method of directly recycling a spent cathode active material by removing a binder from the spent cathode active material without using a conventional solvent and without adversely affecting the morphology and/or structure of the cathode active material so that a high purity cathode active material can be obtained with a high yield. The method includes mixing the spent cathode active material with water to form a first mixture. The spent cathode active material includes cathode active material particles and the binder. The method further includes grinding the first mixture to separate the binder from the cathode active material particles, mixing the first mixture with a hydrocarbon liquid, agitating the hydrocarbon liquid and the first mixture and forming an oil phase and a water phase, and separating the oil phase from the water phase. The first mixture contains the cathode active material particles, the binder and the water. The oil phase contains the hydrocarbon liquid and the binder, and the water phase contains the cathode active material particles and the water.

By using an oil agglomeration method in which the spent cathode active material is mixed with water and then agitated with oil, the binder can be effectively removed from the cathode active material by forming two phases—an oil phase containing the binder and a water phase containing the spent cathode active material—and separating the oil phase from the water phase. Furthermore, by grinding the spent cathode active material after it has been mixed with water, the binder can be better removed from the surface of the spent cathode active material particles before mixing with the oil such that a higher yield and higher purity cathode material can be attained when the oil and water phases are separated.

Another aspect of the present disclosure is to provide a system for removing a binder from a spent cathode active material. The system comprises a first mixer, a grinder, a second mixer and a gravity separation device. The first mixer has a first inlet and a first outlet. The grinder is connected to the first outlet and has a second outlet. The second mixer is connected to the second outlet and has a third outlet. The gravity separation device is connected to the third outlet and has a fourth outlet.

By using a mixer connected to a gravity separation device, binder can be effectively removed from a spent cathode active material by mixing the spent cathode active material with oil and forming two phases in the mixer—an oil phase containing the binder and carbon additive and a water phase containing the spent cathode active material, then separating the oil phase from the water phase using the gravity separation device. Furthermore, by using a grinder after the spent cathode active material has been mixed with water, the binder can be better removed from the surface of the spent cathode active material particles before mixing with the oil such that a higher yield and higher purity cathode material can be attained when the oil and water phases are separated.

### BRIEF DESCRIPTION OF THE DRAWINGS

Referring now to the attached drawings which form a part of this original disclosure:

FIG. 1 is an illustrated flow chart showing a process of removing a binder from a spent cathode active material according to a first embodiment;

FIG. 2 is an illustrated flow chart showing a process of removing a binder from a spent cathode active material according to a second embodiment; and

FIG. 3 is a schematic view of a system for removing a binder from a spent cathode active material according to a third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

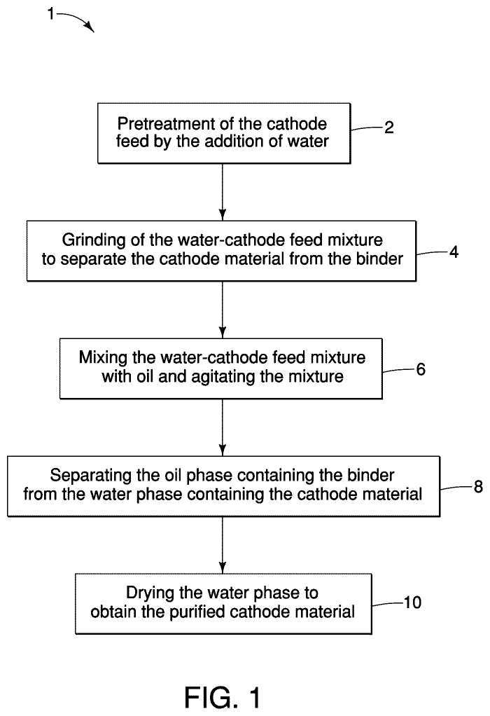

Referring initially to FIG. 1, a process 1 of removing a binder from a spent cathode active material is illustrated in accordance with a first embodiment. The spent cathode active material feed can be removed from a used lithium-ion battery in any suitable manner. The lithium-ion battery may be any suitable lithium-ion battery and can be a battery that was used in a vehicle, a mobile device, a laptop computer or other suitable personal electronic device. The spent cathode active material feed includes a lithium-containing cathode active material. For example, the lithium-containing cathode active material can be NMC, lithium nickel cobalt aluminum oxide having the formula LiNiₓCo_{y}Al_{z}O₂, where x+y+z=1 (“NCA”), lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), LiFePO₄ (“LFP”), and mixtures thereof. The spent cathode active material is preferably NMC.

Although the first embodiment relates to a spent cathode active material from a lithium-ion battery, it should be understood that the following process may also be used for spent cathode active material from a potassium-or sodium-ion battery.

The spent cathode active material feed also includes a binder and optionally an additive. The binder can be any suitable binder containing fluorine. The binder is preferably PVDF. The additive can be any suitable sacrificial electrode additive. For example, the additive is a carbon additive. A total amount of binder and additive in the spent cathode active material feed ranges from 5% by weight to 11% by weight. Thus, an amount of cathode active material in the feed is approximately 89% by weight to 95% by weight.

In Step 2, the lithium-containing spent cathode active material is pretreated by mixing the spent cathode active material feed with water to form a water-cathode feed mixture. The solid concentration of the water-cathode feed mixture ranges from approximately 10% to 50%. Thus, the amount of water mixed with the spent cathode active material feed ranges from approximately 3 kg to 9 kg per 1 kg of spent cathode active material feed such that a weight ratio of the water to the spent cathode active material feed ranges from 3:1 to 9:1.

In Step 2, an additive may optionally be added to the water-cathode feed mixture to control the pH of the mixture. The additive can be any suitable additive or mixture of additives for adjusting the pH of the water, such as sodium hydroxide and/or sulfuric acid.

The pretreatment with water and an optional additive is performed at room temperature (i.e., approximately 20° C. to 22° C.) and atmospheric pressure for any suitable amount of time sufficient to dissolve the spent cathode active material feed in the water. For example, the water and optional additive are mixed with the spent cathode active material feed for approximately 3 minutes to 30 minutes.

The pretreatment can be performed in any suitable mixing apparatus configured to mix the spent cathode active material with the water and optional additive. For example, the pretreatment can be performed in an industrial mixer.

In Step 4, the water-cathode feed mixture is ground to liberate the binder from the spent cathode active material. In particular, due to the grinding, the binder that is on the surface of the spent cathode active material is liberated from the surface of the spent cathode active material such that it is separate from the spent cathode active material in the water mixture. In other words, after grinding, the binder and spent cathode active material are both contained as separate particles or groups of particles in the water.

The grinding can be performed in any suitable mill that is sufficient to liberate the binder from the spent cathode active material. The grinder is preferably a tumbling ball mill or vertical attrition mill. The grinding is performed at any suitable speed for any suitable amount of time. For example, the grinding can be performed at a speed of approximately 20 rpm to 300 rpm, depending on the size of the mill, for approximately 15 minutes to 60 minutes at room temperature (i.e., approximately 20° C. to 22° C.).

In Step 6, the water-cathode feed mixture, in which the binder has been liberated from the spent cathode active material, is mixed with an oil and agitated. The amount of oil mixed with the water-cathode feed mixture ranges from approximately 1 kg to 2 kg per 1 kg of spent cathode active material feed such that a weight ratio of the oil to the spent cathode active material ranges from 1:1 to 2:1. After agitation, the oil and water-cathode feed mixture are allowed to settle, thereby forming an oil phase and a water phase are formed. The oil phase contains the oil and the binder, and the water phase contains the water and the spent cathode active material.

The oil is any suitable oil or oil-based liquid for generating an oil phase that contains the oil and the binder and a water phase that contains the spent cathode active material and the water. For example, the oil is a hydrocarbon liquid such as an alkane. The hydrocarbon liquid is preferably an alkane selected from the group consisting of: pentane, hexane, heptane, octane, nonane and decane. The hydrocarbon liquid is most preferably heptane.

The mixture with oil and agitation is performed in any suitable mixing apparatus that is sufficient to agitate the oil and the water-cathode feed mixture to a degree sufficient to generate an oil phase that contains the binder and a water phase that contains the water and the spent cathode active material. The mixing apparatus is an industrial mixer or a blender. The mixing apparatus is preferably a blender. The agitation can be performed at any suitable speed for any suitable amount of time. For example, the agitation can be performed at a speed of approximately 2,000 rpm to 20,000 rpm for approximately 30 seconds to 2 minutes at room temperature (i.e., approximately 20° C. to 22° C.).

In Step 8, the oil phase containing the oil and the binder is separated from the water phase containing the spent cathode active material and the water. The oil phase may be separated from the water phase in any suitable manner. For example, the oil phase is separated from the water phase using gravity separation in which the oil phase floats above the water phase. In this manner, the oil phase can be separated from the water phase by siphoning off the water phase using a valve. The separation of the oil phase and the water phase can be performed using any suitable gravity separation apparatus. For example, the separation can be performed in a separating funnel. The yield of spent cathode active material in the water phase ranges from approximately 80% to 98% relative to the amount of spent cathode active material in the spent cathode active material feed.

In Step 10, the water phase is dried to separate the cathode active material from the water and obtain a purified cathode active material. The water phase can be dried in any suitable manner. For example, the water phase can be dried at a temperature of 20° C. to 100° C. for any suitable amount of time. The purity of the purified cathode active material is at least 99%, preferably at least 99.5%.

In this embodiment, the mixing and agitation with oil step is performed as a single step. However, it should be understood that the mixing and agitation with oil step can be performed as separate steps.

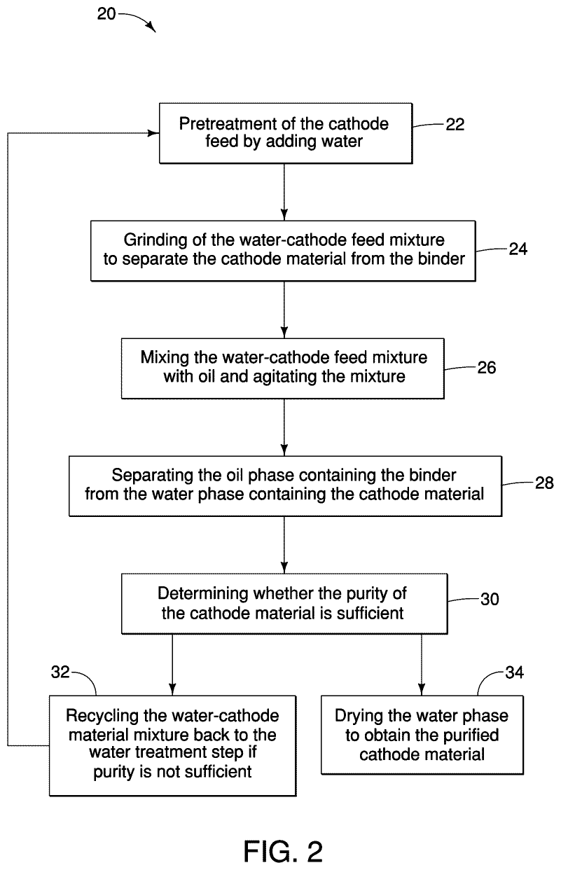

FIG. 2 shows a process 20 of removing a binder from a spent cathode active material is illustrated in accordance with a second embodiment. The spent cathode active material feed can be removed from a used lithium-ion battery in any suitable manner. The lithium-ion battery may be any suitable lithium-ion battery and can be a battery that was used in a vehicle, a mobile device, a laptop computer or other suitable personal electronic device. The spent cathode active material feed includes a lithium-containing cathode active material. For example, the lithium-containing cathode active material can be NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), LFP, and mixtures thereof. The spent cathode active material is preferably NMC.

Although the second embodiment relates to a spent cathode active material from a lithium-ion battery, it should be understood that the following process may also be used for spent cathode active material from a potassium-or sodium-ion battery.

The spent cathode active material feed also includes a binder and an optional additive. The binder can be any suitable binder containing fluorine. The binder is preferably PVDF. The additive in the spent cathode active material feed can be any suitable sacrificial electrode additive. For example, the additive is a carbon additive. A total amount of binder and additive in the spent cathode active material feed ranges from 5% by weight to 11% by weight. Thus, an amount of cathode active material in the feed is approximately 89% by weight to 95% by weight.

In Step 22, the lithium-containing spent cathode active material is pretreated by mixing the spent cathode active material feed with water to form a water-cathode feed mixture. The solid concentration of the water-cathode feed mixture ranges from approximately 10% to 50%. As such, the amount of water mixed with the spent cathode active material feed ranges from approximately 3 kg to 9 kg per 1 kg of spent cathode active material feed such that a weight ratio of the water to the spent cathode active material feed ranges from 3:1 to 9:1, preferably 3:1 to 5:1.

An additive may optionally be added to the water-cathode feed mixture to control the pH of the mixture in Step 22. The additive can be any suitable additive or mixture of additives for adjusting the pH of the water, such as sodium hydroxide and/or sulfuric acid.

The pretreatment with water and optional additive is performed at room temperature (i.e., approximately 20° C. to 22° C.) and atmospheric pressure for any suitable amount of time sufficient to dissolve the spent cathode active material feed in the water. For example, the water and optional additive are mixed with the spent cathode active material feed for approximately 3 minutes to 30 minutes.

The pretreatment can be performed in any suitable mixing apparatus configured to mix the spent cathode active material with the water and an optional additive. For example, the pretreatment can be performed in an industrial mixer.

In Step 24, the water-cathode feed mixture is ground to liberate the binder from the spent cathode active material. In particular, due to the grinding, the binder that is on the surface of the spent cathode active material is liberated from the surface of the spent cathode active material such that it is separate from the spent cathode active material in the water mixture. In other words, after grinding, the binder and spent cathode active material are both contained as separate particles or groups of particles in the water.

The grinding can be performed in any suitable grinder that is sufficient to liberate the binder from the spent cathode active material. The grinder is preferably a ball mill. The grinding is performed at any suitable speed for any suitable amount of time. For example, the grinding can be performed at a speed of approximately 20 rpm to 300 rpm for approximately 15 minutes to 30 minutes at room temperature (i.e., approximately 20° C. to 22° C.).

In Step 26, the water-cathode feed mixture, in which the binder has been liberated from the spent cathode active material, is mixed with an oil and agitated. The amount of oil mixed with the water-cathode feed mixture ranges from approximately 1 kg to 2 kg per 1 kg of spent cathode active material feed such that a weight ratio of the oil to the spent cathode active material ranges from 1:1 to 2:1. After agitation, the oil and water-cathode feed mixture are allowed to settle, thereby forming an oil phase and a water phase are formed. The oil phase contains the oil and the binder, and the water phase contains the water and the spent cathode active material.

The oil is any suitable oil or oil-based liquid for generating an oil phase that contains the oil and the binder and a water phase that contains the spent cathode active material and the water. For example, the oil is an alkane selected from the group consisting of: pentane, hexane, heptane, octane, nonane and decane. The hydrocarbon liquid is preferably heptane.

The mixture with oil and agitation is performed in any suitable mixing apparatus that is sufficient to agitate the oil and the water-cathode feed mixture to a degree sufficient to generate an oil phase that contains the binder and a water phase that contains the water and the spent cathode active material. The mixing apparatus is an industrial mixer or a blender. The mixing apparatus is preferably a blender. The agitation can be performed at any suitable speed for any suitable amount of time. For example, the agitation can be performed at a speed of approximately 2,000 rpm to 20,000 rpm for approximately 30 seconds to 2 minutes at room temperature (i.e., approximately 20° C. to 22° C.).

In Step 28, the oil phase containing the oil and the binder is separated from the water phase containing the spent cathode active material and the water. The oil phase may be separated from the water phase in any suitable manner. For example, the oil phase is separated from the water phase using gravity separation in which the oil phase floats above the water phase. In this manner, the oil phase can be separated from the water phase by siphoning off the water phase using a valve. The separation of the oil phase and the water phase can be performed using any suitable gravity separation apparatus. For example, the separation can be performed in a separating funnel. The yield of spent cathode active material in the water phase ranges from approximately 80% to 98% relative to the amount of spent cathode active material in the spent cathode active material feed.

In Step 30, the water phase is analyzed to determine whether the purity of the spent cathode active material is sufficient. For example, the water phase is analyzed in any suitable manner to determine whether the purity of the spent cathode active material is greater than or equal to a predetermined value. The predetermined value is preferably at least 95%, more preferably at least 98%.

If it is determined that the purity of the spent cathode active material is not sufficient, in Step 32, the water phase is recycled back to the pretreatment Step 22 such that the water phase from Step 32 is mixed with more water to form a second water-cathode feed mixture. This second water-cathode feed mixture is then subjected to the grinding in Step 24 and the mixing with oil and agitation in Step 26 to form a second oil phase and a second water phase. The second oil phase is then separated from the second water phase, and the second water phase is analyzed to determine whether the purity of the cathode active material is sufficient. If not, the second water phase is recycled back to the beginning of the process 20 such that all the steps are repeated until the desired purity of the cathode active material is achieved.

In Step 34, if it is determined that the purity of the spent cathode active material from Step 30 is sufficient, the water phase is dried to separate the cathode active material from the water and obtain a purified cathode active material. The water phase can be dried in any suitable manner. For example, the water phase can be dried at a temperature of 20° C. to 100° C. for any suitable amount of time. The purity of the purified cathode active material is at least 99%, preferably at least 99.5%.

In this embodiment, the mixing and agitation with oil step is performed as a single step. However, it should be understood that the mixing and agitation with oil step can be performed as separate steps.

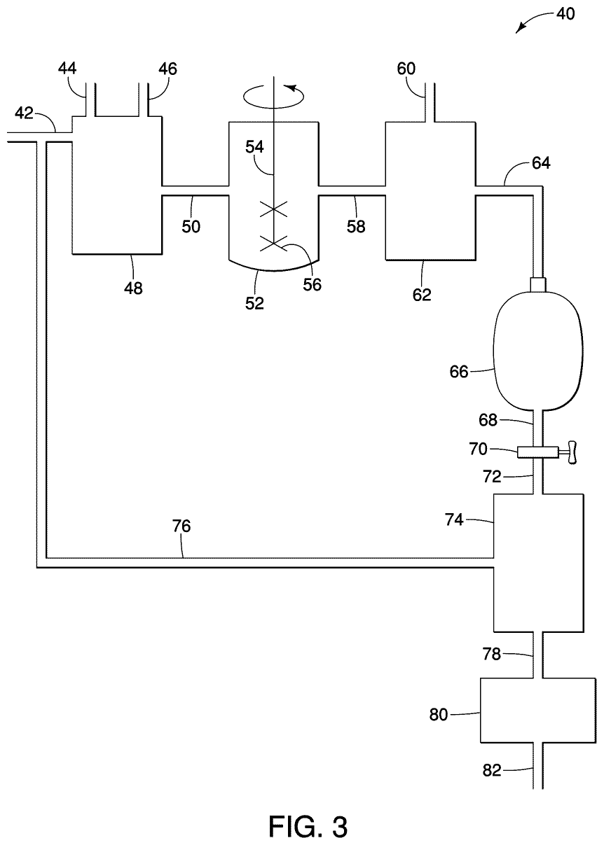

FIG. 3 shows a system 40 for removing a binder from a spent cathode active material in accordance with a third embodiment. The spent cathode active material feed can be removed from a used lithium-ion battery in any suitable manner. The lithium-ion battery may be any suitable lithium-ion battery and can be a battery that was used in a vehicle, a mobile device, a laptop computer or other suitable personal electronic device. The spent cathode active material feed includes a lithium-containing cathode active material. For example, the lithium-containing cathode active material can be NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), LFP, and mixtures thereof. The spent cathode active material is preferably NMC.

Although the second embodiment relates to a spent cathode active material from a lithium-ion battery, it should be understood that the following process may also be used for spent cathode active material from a potassium-or sodium-ion battery.

The system 40 includes a feed inlet 42, a water inlet 44 and an additive inlet 46 connected to a first mixer 48 as shown in FIG. 3. The feed inlet 42 is configured to introduce a spent cathode active material feed containing the spent cathode active material into the first mixer 48. The feed inlet 42 can optionally be connected to a spent cathode active material feed source, such as a tank or other container for storing spent cathode active material feed. The feed inlet 42 is made of any material suitable for introducing the spent cathode active material feed into the first mixer 48. The feed inlet 42 has any suitable size for introducing the spent cathode active material feed into the first mixer 48.

The spent cathode active material feed also includes a binder and an optional additive. The binder can be any suitable binder containing fluorine, such as PVDF. The additive in the spent cathode active material feed can be any suitable sacrificial electrode additive, such as a carbon additive. A total amount of binder and additive in the spent cathode active material feed ranges from 5% by weight to 11% by weight. Thus, an amount of cathode active material in the feed is approximately 89% by weight to 95% by weight.

The water inlet 44 is configured to introduce water into the first mixer 48 to form a water-cathode feed mixture. The solid concentration of the water-cathode feed mixture ranges from approximately 10% to 50%. As such, the amount of water introduced into the first mixer 48 from water inlet 44 ranges from approximately 3 kg to 9 kg per 1 kg of spent cathode active material feed from feed inlet 42 such that a weight ratio of the water to the spent cathode active material feed ranges from 3:1 to 9:1, preferably 3:1 to 5:1.

The first mixer also includes an additive inlet 46 for optionally introducing an additive to the first mixer 48. The additive can be used to control the pH of the water-cathode feed mixture in the first mixer 48. The additive can be any suitable additive or mixture of additives for adjusting the pH of the water, such as sodium hydroxide and sulfuric acid.

The first mixer 48 is any suitable mixing apparatus configured to mix the spent cathode active material feed with the water and an optional additive. For example, the pretreatment can be performed in an industrial mixer. The first mixer 48 is configured to mix the materials introduced from feed inlet 42, water inlet 44 and additive inlet 46 at room temperature (i.e., approximately 20° C. to 22° C.) and atmospheric pressure for any suitable amount of time sufficient to dissolve the spent cathode active material feed in the water. For example, the first mixer 48 is configured to mix the water and optional additive with the spent cathode active material feed for approximately 3 minutes to 30 minutes.

The system 40 also includes an outlet 50 from the first mixer 48. The outlet 50 is connected to a grinder 52 and is configured to feed the water-cathode feed mixture containing the water, the spent cathode active material feed, and any optional additives to the grinder 52.

The grinder 52 includes a rod 54 and blades 56. The grinder 52 is configured to grind the water-cathode feed mixture to thereby liberate the binder from the spent cathode active material. In particular, the grinder 52 is configured to liberate the binder from the surface of the spent cathode active material such that it is separate from the spent cathode active material in the water mixture.

The grinder 52 is any suitable grinder that is sufficient to liberate the binder from the spent cathode active material. The grinder 52 is preferably a ball mill. The grinder 52 is configured to operate at a speed of approximately 20 rpm to 300 rpm for any suitable amount of time. The grinder 52 is preferably configured to operate at the desired speed for approximately 15 minutes to 30 minutes at approximately 20° C. to 22° C.

The grinder 52 includes an outlet 58. The outlet 58 and an oil inlet 60 are both connected to a second mixer 62. The outlet 58 is configured to feed the water-cathode feed mixture, in which the binder has been liberated from the spent cathode active material, from the grinder 52 into a second mixer 62. The oil inlet 60 is configured to introduce oil into the second mixer 62.

The oil is any suitable oil or oil-based liquid for generating an oil phase that contains the oil and the binder and a water phase that contains the spent cathode active material and the water. For example, the oil is an alkane selected from the group consisting of: pentane, hexane, heptane, octane, nonane and decane. The hydrocarbon liquid is preferably heptane.

The oil inlet 60 is configured to introduce a predetermined amount of oil into the second mixer 62. The predetermined amount of oil ranges from approximately 1 kg to 2 kg per 1 kg of spent cathode active material feed such that a weight ratio of the oil to the spent cathode active material from outlet 58 ranges from 1:1 to 2:1. The second mixer 62 is configured to allow the oil and water-cathode feed mixture to settle after agitation and thereby form an oil phase and a water phase in the second mixer 62. The oil phase contains the oil and the binder, and the water phase contains the water and the spent cathode active material.

The second mixer 62 is configured to agitate the oil from oil inlet 60 with the water-cathode feed mixture from outlet 58. The second mixer 62 is any suitable mixing apparatus. The second mixer 62 is an industrial mixer or a blender, preferably a blender. The second mixer 62 is configured to operate at a speed of approximately 2,000 rpm to 20,000 rpm for approximately 30 seconds to 2 minutes at 20° C. to 22° C.

The second mixer 62 includes an outlet 64. The outlet 64 is configured to feed the oil phase and the water phase from the second mixer 62 to a gravity separation device 66. The gravity separation device 66 is any suitable gravity separation device in which the oil phase floats above the water phase and can be separated from the water phase by siphoning off the water phase, such as a separating funnel. As shown in FIG. 3, the gravity separation device 66 includes an outlet 68 and a valve 70. In the gravity separation device The valve 70 is configured to siphon off the water phase from the gravity separation device 66 through line 72. The yield of spent cathode active material in the water phase in line 72 ranges from approximately 80 % to 98% relative to the amount of spent cathode active material in the spent cathode active material feed.

The system 40 also includes an analyzing device 74 configured to determine whether the purity of the spent cathode active material is sufficient. The analyzing device has two outlets—outlet 76 and outlet 78. The device 74 is any suitable device for analyzing the purity of the spent cathode material. For example, the device 74 can be a spectrometer or a gas chromatograph. The device 74 also includes a processor configured to determine whether the purity of the spent cathode active material in the water phase is greater than or equal to a predetermined value. The predetermined value is preferably at least 95%, more preferably at least 98%.

If it is determined that the purity of the spent cathode active material is not sufficient, the water phase is recycled back to the feed inlet 42 through outlet 76 so that the water phase can be mixed with more water in the first mixer 48.

Alternatively, if it is determined that the purity of the spent cathode active material is sufficient, the water phase is sent through outlet 78 to a drier 80. The drier 80 is configured to dry the water phase from outlet 78 in any suitable manner. For example, the drier is configured to operate at a temperature of 20° C. to 100° C. for any suitable amount of time to dry the water phase. The purity of the purified cathode active material after leaving the drier 80 is at least 99%, preferably at least 99.5%.

The system 100 includes an outlet 82 from the drier 80. The outlet 82 is configured to feed the dried and purified cathode active material to another container or device.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A method of removing a binder from a spent cathode active material, the method comprising:
mixing the spent cathode active material with water to form a first mixture, the spent cathode active material including cathode active material particles and the binder;
grinding the first mixture to separate the binder from the cathode active material particles;
mixing the first mixture with a hydrocarbon liquid, the first mixture containing the cathode active material particles, the binder and the water;
agitating the hydrocarbon liquid and the first mixture and forming an oil phase and a water phase; and
separating the oil phase from the water phase,
the oil phase containing the hydrocarbon liquid and the binder, and
the water phase containing the cathode active material particles and the water.

2. The method according to claim 1, further comprising
drying the water phase to form a purified cathode active material.

3. The method according to claim 1, wherein
the cathode active material particles comprise at least one selected from the group consisting of: lithium nickel manganese cobalt oxide, lithium nickel cobalt aluminum oxide lithium cobalt oxide, lithium nickel oxide, lithium manganese oxide, lithium nickel manganese oxide and lithium iron phosphate.

4. The method according to claim 1, wherein
the binder includes fluorine.

5. The method according to claim 4, wherein
the binder comprises polyvinylidene fluoride.

6. The method according to claim 1, wherein
the hydrocarbon liquid comprises at least one selected from the group consisting of: pentane, hexane, heptane, octane, nonane and decane.

7. The method according to claim 6, wherein
the hydrocarbon liquid comprises heptane.

8. The method according to claim 1, wherein
a weight ratio of the hydrocarbon liquid to the cathode active material particles when the first mixture is mixed with the hydrocarbon liquid ranges from approximately 1:1 to 2:1.

9. The method according to claim 1, further comprising:
if a purity of the cathode active material particles in the water phase is below a predetermined value after separation from the oil phase, mixing the water phase with additional water to form a second mixture;
grinding the second mixture;
mixing the second mixture with additional hydrocarbon liquid;
agitating the additional hydrocarbon liquid and the second mixture to form a second oil phase and a second water phase; and
separating the second oil phase from the second water phase.

10. The method according to claim 1, wherein
a weight ratio of the water to the spent cathode active material when the water is mixed with the spend cathode active material ranges from approximately 1:1 to 5:1.

11. The method according to claim 1, wherein
agitating the hydrocarbon liquid and the first mixture to form the oil phase and the water phase is performed at a speed of approximately 2,000 rpm to 20,000 rpm.

12. The method according to claim 1, wherein
grinding the first mixture to separate the binder from the cathode active material particles is performed at a speed of approximately 20 rpm to 300 rpm.

13. The method according to claim 1, wherein
the oil phase is separated from the water phase using gravity separation.

14. A system for removing a binder from a spent cathode active material, the system comprising:
a first mixer having a first inlet and a first outlet;
a grinder connected to the first outlet and having a second outlet;
a second mixer connected to the second outlet and having a third outlet; and
a gravity separation device connected to the third outlet and having a fourth outlet.

15. The system according to claim 14, wherein
the second mixer is a blender configured to operate at a speed of approximately 2,000 rpm to 20,000 rpm.

16. The system according to claim 14, wherein
the grinder is configured to operate at a speed of approximately 20 rpm to 300 rpm.

17. The system according to claim 14, wherein:
the gravity separation device further comprises a fifth outlet, and
the fifth outlet is connected to the first mixer.

18. The system according to claim 14, further comprising
a drier connected to the fourth outlet.

19. The system according to claim 14, wherein
the gravity separation device is a separation funnel.

20. The system according to claim 14, wherein
the grinder is a ball mill.
